(19) United States
(12) Patent Application Publication
(10) Pub. No.: US 2010/0041819 A1
(43) Pub. Date: Feb. 18, 2010

(54) FLUORINATED SURFACTANTS AND METHOD OF MAKING THE SAME

(76) Inventors: George G. I. Moore, Afton, MN (US); Rudolf J. Dams, Antwerp (BE)

Correspondence Address: 3M INNOVATIVE PROPERTIES COMPANY, PO BOX 33427, ST. PAUL, MN, 55133-3427, US

(21) Appl. No.: 12/444,721

(22) PCT Filed: Oct. 11, 2007
(86) PCT No.: PCT/US07/81086

§ 371 Date: Apr. 8, 2009

Related U.S. Application Data
(60) Provisional application No. 60/829,192, filed on Oct. 12, 2006.

(51) Int. Cl. C08G 75/26; C08L 67/00

(52) U.S. Cl. 524/538; 528/360; 524/599

(57) ABSTRACT

Fluorinated surfactants having a weight average molecular weight in a range from 1200 to 10000 grams per mole, wherein the fluorinated surfactant comprises at least one component represented by formula or a salt thereof, wherein: R is H, —CH₃, or —CH₂CO₂H; and m is an integer having a value from 0 to 11. Z is a divalent segment consisting of copolymerized units of perfluoroalkanesulfonamidoalkyl (meth)acrylate and at least one of (meth)acrylic acid, β-carboxyethyl (meth)acrylic acid, or itaconic acid. The molar ratio of perfluoroalkanesulfonamidoalkyl to carboxylic acid groups in the fluorinated surfactant has a value from 0.5 to 3. Methods of making the fluorinated surfactants are also disclosed.

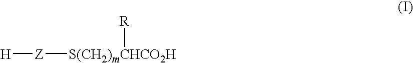

### BACKGROUND

Fluorinated surfactants have been widely used in industrial coatings for many years. Fluorinated surfactants can affect the properties of these coatings such as, for example, wetting behavior, leveling properties, and storage stability (e.g., with respect to phase separation). The particular properties affected depend, for example, on the particular composition of each surfactant and the particular coating formulation. Surfactants that are useful leveling agents lower the surface energy of a formulation and maintain that surface energy at a nearly constant value during drying. However, in general, the ability of a surfactant to lower the surface tension of a solvent or formulation (i.e., the surfactant strength) has little predictive value in determining whether that surfactant will function well as a leveling agent in a coating formulation.

Traditionally many of the fluorinated surfactants widely used in industrial coatings include long-chain perfluoroalkyl groups, for example, perfluorooctyl groups. Recently, however, there has been an industry trend away from using perfluorooctyl fluorinated surfactants, which has resulted in a desire for new types of surfactants.

### SUMMARY

In one aspect, the present invention provides a fluorinated surfactant having a weight average molecular weight in a range from 1200 to 10000 grams per mole, wherein the fluorinated surfactant comprises at least one component represented by formula (I):

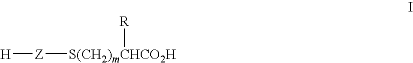

or a salt thereof, wherein

R is selected from the group consisting of —H, —CH₃, and —CH₂CO₂H;

m is an integer having a value from 0 to 11; and

Z is a divalent segment consisting of:
p divalent groups independently represented by formula (II):

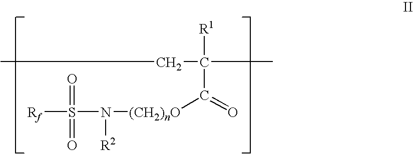

wherein
   R¹ is selected from the group consisting of —H and —CH₃;
   R² is an alkyl group having from 1 to 4 carbon atoms;
   R_{f} is selected from the group consisting of —C₄F₉ and —C₃F₇;
   n is an integer having a value from 2 to 11; and
   p is an integer having a value from 1 to 18; and
q divalent groups independently represented by formula (III):

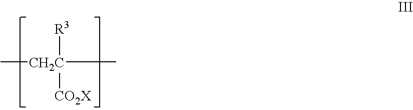

or a salt thereof, wherein
   R³ is selected from the group consisting of H, —CH₃, and —CH₂CO₂H;
   X is selected from the group consisting of —H and —CH₂CH₂CO₂H; and
   q is an integer having a value from 1 to 35;

wherein the fluorinated surfactant has a combined total number of

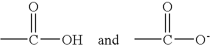

groups represented by k, and wherein p/k has a value from 0.5 to 3.

In another aspect, the present invention provides a fluorinated surfactant preparable by copolymerizing components consisting of:
at least one first component independently represented by formula (IV):

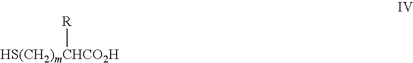

or a salt thereof, wherein
   R is selected from the group consisting of —H, —CH₃, and —CH₂CO₂H; and
   m is an integer having a value from 0 to 11;
at least one second component independently represented by formula (V):

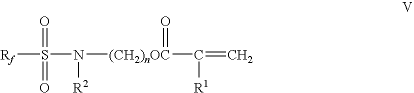

wherein
   R¹ is selected from the group consisting of —H and —CH₃;
   R² is an alkyl group having from 1 to 4 carbon atoms;
   R_{f} is selected from the group consisting of —C₄F₉ and —C₃F₇; and
   n is an integer having a value from 2 to 11; and
at least one third component independently selected from the group consisting of acrylic acid, methacrylic acid, β-carboxyethyl acrylate, β-carboxyethyl methacrylate, itaconic acid, and salts thereof,

wherein
said at least one first component and said at least one third component have a combined total number of moles of

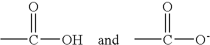

groups represented by j,
a combined total number of moles of said at least one second component is represented by g, and
g/j is in a range from 0.5 to 3; and

wherein amounts of said at least one first, at least one second and at least one third components are selected such that the fluorinated surfactant has a weight average molecular weight in a range from 1200 to 10000 grams per mole. In some embodiments, copolymerizing is carried out in the presence of an initiator, (e.g., a free-radical initiator).

In another aspect, the present invention provides a liquid fluorinated surfactant concentrate comprising a fluorinated surfactant according to the present invention at least one of dissolved or dispersed in a liquid vehicle, the liquid vehicle comprising at least one of water or organic solvent (e.g., a water-soluble organic solvent). In some embodiments, the fluorinated surfactant may be present in the liquid fluorinated surfactant concentrate in an amount of at least 10, 20, 30, 40, or even at least 50 percent by weight or more, based on the total weight of the liquid fluorinated surfactant concentrate.

In another aspect, the present invention provides a formulation (e.g., for coating) comprising water, a polymeric material, and a fluorinated surfactant according to the present invention.

In another aspect, the present invention provides a method of making a fluorinated surfactant, the method comprising copolymerizing components consisting of:
at least one first component independently represented by formula (IV):

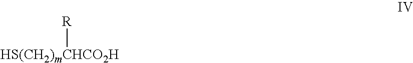

or a salt thereof, wherein
   R is selected from the group consisting of —H, —CH₃, and —CH₂CO₂H; and
   m is an integer having a value from 0 to 11;
at least one second component independently represented by formula (V):

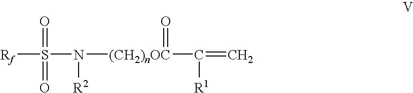

wherein
   R¹ is selected from the group consisting of —H and —CH₃;
   R² is an alkyl group having from 1 to 4 carbon atoms;
   R_{f} is selected from the group consisting of —C₄F₉ and —C₃F₇; and
   n is an integer having a value from 2 to 11; and
at least one third component independently selected from the group consisting of acrylic acid, methacrylic acid, β-carboxyethyl acrylate, β-carboxyethyl methacrylate, itaconic acid, and salts thereof,

wherein
said at least one first component and said at least one third component have a combined total number of moles of

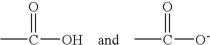

groups represented by j,
a combined total number of moles of said at least one second component is represented by g, and
g/j is in a range from 0.5 to 3; and

wherein amounts of said at least one first, at least one second and at least one third components are selected such that the fluorinated surfactant has a weight average molecular weight in a range from 1200 to 10000 grams per mole. In some embodiments, copolymerizing is carried out in the presence of an initiator (e.g., a free-radical initiator).

In some embodiments of the foregoing aspects, R_{f} is —C₄F₉. In some embodiments, R¹ and/or R³ is —H. In some embodiments, R² is —CH₃.

Fluorinated surfactants according to, and/or prepared by, the various aspects of present invention typically exhibit properties associated with surfactants, (e.g., wetting or leveling), and in many cases exhibit leveling properties that make them useful as coating additives, for example, in floor finish formulations. Further, fluorinated surfactants according to the present invention typically have high mobility in liquid formulations, but relatively low mobility in dried or cured coatings.

Typically, fluorinated surfactants according to the present invention exhibit surfactant properties in formulations containing water. In some embodiments, fluorinated surfactants according to the present invention have a solubility in water at 22° C. of at least 10 parts per million by weight.

In one aspect, the present invention provides a method of reducing surface tension of a liquid, (e.g., water), the method comprising combining the liquid with a fluorinated surfactant according to the present invention in an amount sufficient to reduce the surface tension of the liquid.

In this application:

“Salt” refers to an ionic compound whose anion comes from an acid and whose cation comes from a base. In the case of a carboxylic acid, the salt may be represented, for example, by the formula —CO₂⁻M⁺ wherein M⁺ represents a monovalent cation such as, for example, an alkali metal cation (e.g., Li⁺, Na⁺, K⁺, Cs⁺), NH₄⁺, an organoammonium cation, an organosulfonium ion, or an organophosphonium cation.

“Waterborne” refers to at least one of dissolved or dispersed in a liquid material comprising water and optionally one or more water-soluble organic solvents.

All numerical ranges are inclusive of their endpoints unless otherwise stated.

### DETAILED DESCRIPTION

Fluorinated surfactants according to the present invention have weight average molecular weights in a range from 1200, 1500, 1800, 2000, or even 2500 grams per mole up to 3000, 3500, 4000, 4500, 5000, 5500, 6000, 6500, 7000, 7500, 8000, 8500, 9000, 9500, or even up to 10000 grams per mole; for example, in a range from 1500 to 8000 grams per mole. In some embodiments, fluorinated surfactants according to the present invention have weight average molecular weights in a range from 1500 to 4000 grams per mole. Fluorinated surfactants according to the present invention typically have a distribution of molecular weights and compositions. Weight average molecular weights can be measured, for example, by gel permeation chromatography (i.e., size exclusion chromatography) using techniques known to one of skill in the art.

Fluorinated surfactants according to the present invention comprise at least one component represented by formula (I):

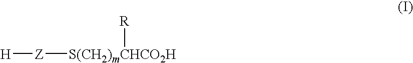

or a salt thereof.

R is selected from the group consisting of —H, —CH₃, and —CH₂CO₂H. In some embodiments, R is selected from the group consisting of —H and —CH₂CO₂H. In some embodiments, R is —H. In some embodiments, R is —CH₂CO₂H.

In formula I, m is an integer having a value from 0 to 11 (i.e., 0, 1, 2, 3, 4, 5, 6, 7, 8, 9, 10, or 11). In some embodiments, m is an integer having a value from 0 to 4. In some embodiments, m is 0.

Z is a divalent segment consisting of:

p divalent groups independently represented by formula (II):

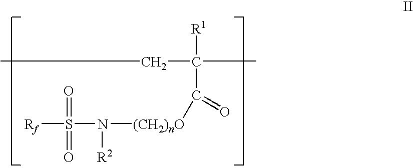

wherein
   R¹ is selected from the group consisting of —H and —CH₃;
   R² is an alkyl group having from 1 to 4 carbon atoms (e.g., methyl, ethyl, n-propyl, isopropyl, n-butyl, isobutyl, or sec-butyl);
   R_{f} is selected from the group consisting of —C₄F₉ and —C₃F₇ (e.g., perfluoro-n-butyl, perfluoroisobutyl, perfluoro-sec-butyl, perfluoro-tert-butyl, perfluoro-n-propyl, or perfluoroisopropyl);
   n is an integer having a value from 2 to 11 (i.e., 2, 3, 4, 5, 6, 7, 8, 9, 10, or 11); and
   p is an integer having a value from 1 to 18 (i.e., 1, 2, 3, 4, 5, 6, 7, 8, 9, 10, 11, 12, 13, 14, 15, 16, 17, or 18); and
q divalent groups independently represented by formula (III):

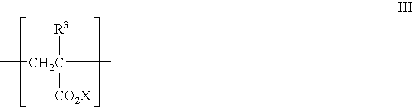

or a salt thereof, wherein
   R³ is selected from the group consisting of H, —CH₃, and —CH₂CO₂H;
   X is selected from the group consisting of —H and —CH₂CH₂CO₂H; and
   q is an integer having a value from 1 to 35 (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, or 35).

In some embodiments, n is an integer having a value from 2 to 6. In some embodiments, n is an integer having a having a value from 2 to 4. In some embodiments, R¹ and/or R³ is —H. In some embodiments, R_{f} is —C₄F₉. In some embodiments, R² is —CH₃. In some embodiments, X is —H.

Fluorinated surfactants according to the present invention have a combined total number of

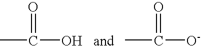

groups represented by k, and p/k has a value from 0.5 to 3 (e.g., 0.75, 1, 1.25, 1.33, 1.66, 2, 2.3, 2.4, or 2.66). In some embodiments, p/k has a value from 1 to 3, or even 2 to 3. In some embodiments, p/k has a value from 0.5 to 2 or even 0.5 to 1.5. In some embodiments, p/k has a value of 0.75.

Typically, fluorinated surfactants according to the present invention exhibit surfactant properties in waterborne formulations. Fluorinated surfactants according to the present invention have a balance between hydrophobic and hydrophilic groups (e.g., a p/k from 0.5 to 3) and low weight average molecular weights (e.g., 1200 to 10000), factors which render them at least one of soluble or dispersible in waterborne formulations. In some embodiments, fluorinated surfactants according to the present invention have a solubility in water at 22° C. of at least 10 parts per million (ppm) by weight, at least 100 ppm by weight, or even at least 1000 ppm by weight.

In some embodiments, the p divalent groups independently represented by formula II and the q divalent groups independently represented by formula III or a salt thereof are randomly copolymerized in the divalent segment Z.

In some embodiments, the divalent segment Z consists of p divalent groups represented by formula II and q divalent groups represented by formula III or a salt thereof (i.e., the divalent groups represented by formula II are not independently selected, and the divalent groups represented by formula III are not independently selected).

Fluorinated surfactants according to the present invention may be formulated into concentrates (e.g., in water, solvent, or a combination thereof). Techniques for preparing concentrates are well known in the art.

Fluorinated surfactants according to the present invention may be prepared, for example, by copolymerizing a mixture containing at least one first, at least one second, and at least one third components typically in the presence of an initiator. In some embodiments, fluorinated surfactants according to the present invention are preparable by copolymerizing components consisting of at least one first, at least one second, and at least one third components. By the term “copolymerizing” it is meant forming a polymer or oligomer that includes at least one identifiable structural element due to each of the first, second, and third components. Typically the polymer or oligomer that is formed has a distribution of molecular weights and compositions.

The first component is a mercaptan-containing chain transfer agent for free-radical polymerization, and is represented by the formula (IV):

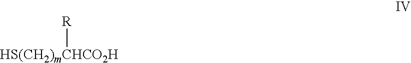

or a salt thereof, wherein

R is selected from the group consisting of —H, —CH₃, and —CH₂CO₂H; and

m is an integer having a value from 0 to 11 (i.e., 0, 1, 2, 3, 4, 5, 6, 7, 8, 9, 10, or 11). In some embodiments, R is selected from the group consisting of —H and —CH₂CO₂H. In some embodiments, R is —H. In some embodiments, R is —CH₂CO₂H. In some embodiments, m is an integer having a value from 0 to 4. In some embodiments, m is 0.

The second component is a fluorinated free-radically polymerizable monomer represented by the formula (V):

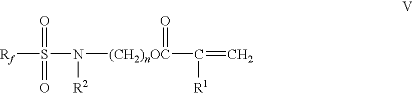

wherein

R¹ is selected from the group consisting of —H and —CH₃;

R² is an alkyl group having from 1 to 4 carbon atoms (e.g., methyl, ethyl, n-propyl, isopropyl, n-butyl, isobutyl, or sec-butyl);

R_{f} is selected from the group consisting of —C₄F₉ and —C₃F₇ (e.g., perfluoro-n-butyl, perfluoroisobutyl, perfluoro-sec-butyl, perfluoro-tert-butyl, perfluoro-n-propyl, or perfluoroisopropyl); and

n is an integer having a value from 2 to 11 (i.e., 2, 3, 4, 5, 6, 7, 8, 9, 10, or 11). In some embodiments, n is an integer having a value from 2 to 6. In some embodiments, n is an integer having a having a value from 2 to 4.

The third component is acrylic acid, methacrylic acid, β-carboxyethyl acrylate, β-carboxyethyl methacryate, itaconic acid, a mixture thereof, or a salt thereof. In some embodiments, the third component is acrylic acid, methacrylic acid, β-carboxyethyl acrylate, a mixture thereof, or a salt thereof. In some embodiments, the third component is acrylic acid.

Fluorinated free-radically polymerizable monomers of formula V, and methods for their preparation, are known in the art; (see, e.g., U.S. Pat. Nos. 2,803,615 (Albrecht et al.) and 6,664,354 (Savu et al.), the disclosures of which, relating to free-radically polymerizable monomers and methods of their preparation, are incorporated herein by reference). Compounds of formula IV, acrylic acid, methacrylic acid, β-carboxyethyl acrylate, β-carboxyethyl methacryate, itaconic acid, and/or salts thereof are available from general chemical suppliers (e.g., Sigma-Aldrich Company, Saint Louis, Mo.) or may be synthesized by conventional methods.

In some embodiments, mixtures of more than one first component, and/or more than one second component, and/or more than one third component can be used. In other embodiments, one first component, one second component, and one third component can be used.

The first and third components have a total number of moles of

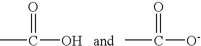

groups represented by j, and the second component has a combined total number of moles represented by g. The ratio of g/j should be 0.5 to 3 (e.g., 0.75, 1, 1.25, 1.33, 1.66, 2, 2.3, 2.4, or 2.66), 1 to 3, or even 2 to 3. In some embodiments, the ratio of g/j is 0.5 to 2 or even 0.5 to 1.5. In some embodiments, g/j has a value of 0.75. Further, the amounts of the first, second, and third components and, typically, the free radical initiator are selected such that the weight average molecular weight of the copolymerized components has a value from 1200, 1500, 1800, 2000, or even 2500 grams per mole up to 3000, 3500, 4000, 4500, 5000, 5500, 6000, 6500, 7000, 7500, 8000, 8500, 9000, 9500, or even up to 10000 grams per mole. In some embodiments, the weight average molecular weight of the copolymerized components has a value from 1500 to 8000 grams per mole, or even 1500 to 4000 grams per mole.

Copolymerization of the first, second, and third components is typically carried out in the presence of an added free-radical initiator. Free radical initiators such as, for example, those widely known and used in the art may be used to initiate polymerization of the components. Examples of free-radical initiators include azo compounds (e.g., 2,2′-azobisisobutyronitrile (AIBN), 2,2′-azobis(2-methylbutyronitrile), or azo-2-cyanovaleric acid), hydroperoxides (e.g., cumene, tert-butyl or tert-amyl hydroperoxide), dialkyl peroxides (e.g., di-tert-butyl or dicumylperoxide), peroxyesters (e.g., tert-butyl perbenzoate or di-tert-butyl peroxyphthalate), diacylperoxides (e.g., benzoyl peroxide or lauryl peroxide). When heated (or in some cases photolyzed) such free-radical initiators fragment to generate free radicals which add to ethylenically unsaturated bonds and initiate polymerization. Examples of common initiator residues include hydroxyl groups, alkoxy groups (e.g., tert-butoxy), aroyloxy groups (e.g., benzoyloxy), cyanoalkyl groups (e.g., 2-cyanopropan-2-yl), and substituted versions thereof.

Free-radical photoinitiators may also be used to initate polymerization of the first, second, and third components. Useful photoinitiators include benzoin ethers (e.g., benzoin methyl ether or benzoin butyl ether); acetophenone derivatives (e.g., 2,2-dimethoxy-2 phenylacetophenone or 2,2-diethoxyacetophenone); and acylphosphine oxide derivatives and acylphosphonate derivatives (e.g., diphenyl-2,4,6-trimethylbenzoylphosphine oxide, isopropoxyphenyl-2,4,6-trimethylbenzoylphosphine oxide, or dimethyl pivaloylphosphonate).

Polymerization reactions may be carried out in any solvent suitable for organic free-radical polymerizations. The components may be present in the solvent at any suitable concentration, (e.g., from about 5 percent to about 90 percent by weight based on the total weight of the reaction mixture). Illustrative examples of suitable solvents include aliphatic and alicyclic hydrocarbons (e.g., hexane, heptane, cyclohexane), aromatic solvents (e.g., benzene, toluene, xylene), ethers (e.g., diethyl ether, glyme, diglyme, diisopropyl ether), esters (e.g., ethyl acetate, butyl acetate), alcohols (e.g., ethanol, isopropyl alcohol), ketones (e.g., acetone, methyl ethyl ketone, methyl isobutyl ketone), sulfoxides (e.g., dimethyl sulfoxide), amides (e.g., N,N-dimethylformamide, N,N-dimethylacetamide), halogenated solvents (e.g., methylchloroform, 1,1,2-trichloro-1,2,2-trifluoroethane, trichloroethylene or trifluorotoluene), and mixtures thereof.

Polymerization can be carried out at any temperature suitable for conducting an organic free-radical reaction. Particular temperature and solvents for use can be selected by those skilled in the art based on considerations such as, for example, the solubility of reagents, the temperature required for the use of a particular initiator, and the molecular weight desired. While it is not practical to enumerate a particular temperature suitable for all initiators and all solvents, generally suitable temperatures are in a range from about 30° C. to about 200° C. Adjusting, for example, the concentration and activity of the initiator, the concentration of monomers (i.e., the second and third components), the temperature, and the chain transfer agent (i.e., the first component) can control the molecular weight of the polyacrylate copolymer.

Fluorinated surfactants according to the present invention may be useful in a number of applications. For example, the fluorinated surfactants according to the present invention may be used as industrial coating additives to provide better wetting and/or leveling of a coating (e.g., a waterborne coating) to a substrate surface or better dispersability of a component (e.g., a thickening agent or pigment) within the coating formulation.

When used in waterborne formulations, (e.g., for industrial coatings), fluorinated surfactants according to the present invention can be formulated into an aqueous solution or dispersion at a final concentration, for example, of about 0.001 to about 1 weight percent (wt. %), about 0.001 to about 0.5 wt. %, or about 0.01 to about 0.3 wt. %, based on the weight of the solution or dispersion.

Waterborne formulations (e.g., for industrial coatings) can also include at least one polymeric material, typically a film-forming polymer. Examples of suitable polymers include acrylic polymers, (e.g., poly(methyl methacrylate-co-ethyl acrylate) or poly(methyl acrylate-co-acrylic acid)); polyurethanes, (e.g., reaction products of aliphatic, cycloaliphatic or aromatic diisocyanates with polyester glycols or polyether glycols); polyolefins, (e.g., polystyrene); copolymers of styrene with acrylate(s) (e.g., poly(styrene-co-butyl acrylate); polyesters, (e.g., polyethylene terephthalate, polyethylene terephthalate isophthalate, or polycaprolactone); polyamides, (e.g., polyhexamethylene adipamide); vinyl polymers, (e.g., poly(vinyl acetate/methyl acrylate), poly(vinylidene chloride/vinyl acetate); polydienes, (e.g., poly(butadiene/styrene)); cellulosic derivatives including cellulose ethers and cellulose esters, (e.g., ethyl cellulose, or cellulose acetate/butyrate), urethane-acrylate copolymers, and combinations thereof. Methods and materials for preparing aqueous emulsions or latexes of such polymers are well known, and many are widely available from commercial sources. In one embodiment, the invention provides a formulation comprising water, a polymeric material, and a fluorinated surfactant according to, or made by a method according to, the present invention, wherein the polymeric material is selected from the group consisting of an acrylic polymer, a polyurethane, polystyrene, and a copolymer of styrene and at least one acrylate.

Waterborne formulations may also contain one or more cosolvents (e.g., coalescing solvents) including ethers of polyhydric alcohols (e.g., ethylene glycol monomethyl (or monoethyl)ether, diethylene glycol methyl (or ethyl)ether, triethylene glycol monomethyl (or monoethyl)ether, 2-butoxyethanol (i.e., butyl cellusolve), or di(propylene glycol) methyl ether (DPM)); alkylene glycols and polyalkylene glycols (e.g., ethylene glycol, propylene glycol, butylene glycol, triethylene glycol, hexylene glycol, diethylene glycol, polyethylene glycol, polypropylene glycol); and 2,2,4-trimethyl-1,3-pentanediol monoisobutyrate (an ester alcohol available from Eastman Chemical Company, Kingsport, Tenn., under the trade designation “TEXANOL”). Other water-miscible organic solvents that may be added to a formulation include alcohols having 1 to 4 carbon atoms (e.g., methanol, ethanol, isopropanol, or isobutanol); amides and lactams, (e.g., N,N-dimethylformamide, N,N-dimethylacetamide, or N-methylpyrrolidone); ketones and ketoalcohols (e.g., acetone, cyclohexanone, methyl isobutyl ketone, diacetone alcohol); ethers (e.g., tetrahydrofuran or dioxane); 1,3-dimethyl-2-imidazolidinone; and combinations thereof.

Depending on the application, waterborne formulations may also include at least one additive (e.g., biocides, fillers, additional leveling agents, emulsifiers, defoamers, anticorrosive agents, dispersants, or rust inhibitors). The formulation may also optionally contain at least one pigment.

When a waterborne formulation is applied to a substrate, water and solvent evaporate, and the polymer particles coalesce to form a continuous film. Waterborne formulations are typically applied, dried, and optionally heated, leaving the finished product with a solid coating. The addition of fluorinated surfactants according to the present invention may improve the film forming properties of some formulations by improving the ability of the coating to wet the substrate and/or by allowing for even evaporation of the water (i.e., leveling) during film formation. Fluorinated surfactants according to the present invention may also impart corrosion-resistant properties to the final solid coating, which provides an additional benefit when the substrate is a metallic substrate (e.g., an electronic component).

Waterborne coating formulations that may be improved by the addition of fluorinated surfactants according to the present invention include floor polishes and finishes, varnishes for a variety of substrates (e.g., wood floors), waterborne gels applied in the manufacture of photographic film, automotive or marine coatings (e.g., primers, base coats, or topcoats), sealers for porous substrates (e.g., wood, concrete, or natural stone), hard coats for plastic lenses, coatings for metallic substrates (e.g., cans, coils, electronic components, or signage), inks (e.g., for pens or gravure, screen, or thermal printing), and coatings used in the manufacture of electronic devices (e.g., photoresist inks). The formulations may be clear or pigmented.

Waterborne coating formulations may be applied by many methods known to one of skill in the art (e.g., brushing, mopping, bar coating, spraying, dip coating, gravure coating, or roll coating).

Fluorinated surfactants according to the present invention may be useful in alkaline waterborne coating formulations, such as amine-stabilized floor finish formulations.

Fluorinated surfactants according to the present invention may also be useful as additives in cleaning solutions and may provide improved wetting of the surface and/or the contaminants to be removed. A cleaning solution is typically formulated to include about 0.001 to about 1 wt. %, or about 0.001 to about 0.5 wt. % surfactant, based on the weight of the cleaning solution. For hard-surface cleaning, a cleaning solution is sprayed (e.g., from a spray bottle) or otherwise applied to a hard surface such as window glass, a mirror, or ceramic tile, and the surface is wiped clean with a paper or fabric wipe. The contaminated part may also be immersed or dipped into the cleaning solution. For cleaning solutions used in the manufacture of electronic materials, the solution is typically placed in a bath, and electronic parts are either dipped or run through the bath on a conveyor belt.

In any of the aforementioned coating or cleaning-solution formulations, fluorinated surfactants according to the present invention can be used individually or in combination with hydrocarbon or silicone surfactants or other fluorinated surfactants to produce the desired surface tension reduction or wetting improvement. Useful auxiliary surfactants may be found, for example, in Industrial Applications Of Surfactants, D. R. Karsa, Ed., Royal Society of Chemistry, London, and M. Rosen, Surfactants and Interfacial Phenomena, Wiley-Interscience, New York.

The above applications are not meant to be limiting but only exemplary. Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight. The ratios of N-methylperfluorobutanesulfonamidoethyl acrylate (MeFBSEA) to —C(O)OH and —C(O)O— groups reported in the Examples below are molar ratios based on the amounts of starting monomers.

In the following examples, MeFBSEA was made according to the method of U.S. Pat. No. 6,664,354 (Savu), Example 2, Parts A and B, incorporated herein by reference, except using 4270 kg of N-methylperfluorobutanesulfonamidoethanol, 1.6 kg of phenothiazine, 2.7 kg of methoxyhydroquinone, 1590 kg of heptane, 1030 kg of acrylic acid, 89 kg of methanesulfonic acid (instead of triflic acid), and 7590 kg of water in Part B.

### Weight Average Molecular Weight Determination

The weight average molecular weights of Examples 1-10, 12, and 17 were determined by comparison to linear polystyrene polymer standards using gel permeation chromatography (GPC).

The GPC measurements for Examples 1-10 were carried out using a 300 mm by 7.5 mm column of 3 micrometer styrene divinylbenzene copolymer particles (available from Polymer Laboratories, Shropshire, UK, under the trade designation “PLGEL 3 μm MIXED-E”) and a refractive index detector. A sample of each unneutralized oligomer was derivatized with diazomethane and evaporated to dryness. The sample was then dissolved in stabilized tetrahydrofuran at a concentration of 0.5% (weight/volume). A sample volume of 100 microliters was injected onto the column, and the column temperature was 40° C. A flow rate of 1 milliliter (mL)/minute was used. Molecular weight calibration was performed using narrow dispersity polystyrene standards with peak average molecular weights ranging from 7.3×10⁶ grams per mole to 1300 grams per mole. Calibration and molecular weight distribution calculations were performed using suitable GPC software using a first order polynomial fit for the molecular weight calibration curve.

The GPC measurements for Examples 12 and 17 were carried out using four 300 mm by 7.5 mm linear columns of 5 micrometer styrene divinylbenzene copolymer particles (available from Polymer Laboratories, Shropshire, UK, under the trade designation “PLGEL”) with pore sizes of 10,000, 1000, 500, and 100 angstroms. An evaporative light scattering detector from Polymer Laboratories was used at 45° C. and a nitrogen flow rate of 10 mL/min. A 50-milligram (mg) sample of oligomer at 25% solids in ethyl acetate was diluted with 4 mL of tetrahydrofuran and treated with diazomethane. The resulting solution was dried under a stream of nitrogen, and the sample was then diluted with tetrahydrofuran (10 mL of UV grade) and filtered through a 0.45 micrometer syringe filter. A sample volume of 50 microliters was injected onto the column, and the column temperature was room temperature. A flow rate of 1 mL/minute was used. Molecular weight calibration was performed using narrow dispersity polystyrene standards with peak average molecular weights ranging from 1.1×10⁶ grams per mole to 580 grams per mole. Calibration and molecular weight distribution calculations were performed using suitable GPC software using a third order polynomial fit for the molecular weight calibration curve.

### Example 1

In a 500-mL flask, MeFBSEA (37 grams (g), 0.09 mole (mol)), acrylic acid (4.3 g, 0.06 mol), and mercaptosuccinic acid (4.5 g, 0.03 mol) were combined, and the mixture was diluted with isopropanol (IPA) to approximately 50% solids. 2,2′-Azobis(2-methylpropionitrile) (AIBN) (0.1%) was added, and the reaction was degassed three times using vacuum and nitrogen and heated under a nitrogen atmosphere for six hours at 70° C. Additional AIBN (0.05%) was added, and heating was continued at 70° C. for an additional 16 hours. The weight average molecular weight of the polymer was determined to be 1800 by GPC. The ratio of MeFBSEA to —C(O)OH and —C(O)O⁻ groups was 0.75.

The reaction was diluted with IPA to 30% solids. Dimethylethanolamine (DMEOA) (12.6 g, 0.12 mol) was added to neutralize the acid, and the mixture was further diluted with deionized water to 25% solids. At 25% solids and 50° C., the mixture was visually determined to be a one-phase, clear, and stable solution.

Deionized water was added at three dilution levels to provide solutions containing 1000 parts per million (ppm), 100 ppm, and 10 ppm of neutralized oligomer.

### Examples 2-6

Examples 2-6 were prepared as described for Example 1 except using the reagents and amounts indicated in Table 1 (below).

TABLE 1

| | | | | Molar ratio of | Weight |
|---|---|---|---|---|---|
| | | Acrylic | Mercaptosuccinic | MeFBSEA to | Average |
| | MeFBSEA | Acid | acid | —C(O)OH and | Molecular |
| Example | (g, mol) | (g, mmol) | (g, mmol) | —C(O)O⁻ groups | Weight |
| 2 | 61.6, 0.15 | 4.3, 0.06 | 4.5, 0.03 | 1.25 | 2650 |
| 3 | 98.6, 0.24 | 4.3, 0.06 | 4.5, 0.03 | 2 | 3700 |
| 4 | 98.6, 0.24 | 8.6, 0.03 | 4.5, 0.03 | 1.33 | 3980 |
| 5 | 37, 0.09 | 2.8, 0.03 | 6.8, 0.045 | 0.75 | 2040 |
| 6 | 61.6, 0.15 | 6.5, 0.09 | 4.5, 0.03 | 1 | 2500 |

At 25% solids and 50° C., the mixtures containing the neutralized oligomers of Examples 2, 5, and 6 were visually determined to be one-phase, clear, and stable solutions, and the mixtures containing the neutralized oligomers of Examples 3 and 4 were one-phase, hazy solutions. The weight average molecular weights of the oligomers were determined by GPC and are listed in Table 1 (above).

### Examples 7-10

Examples 7-10 were prepared as described in Example 1 except using 3-mercaptopropionic acid instead of mercaptosuccinic acid and using amounts indicated in Table 2 (below) and using the dilution method described below for Examples 9 and 10.

TABLE 2

| | | | | Molar ratio of | Weight |
|---|---|---|---|---|---|
| | | Acrylic | Mercaptopropionic | MeFBSEA to | Average |
| | MeFBSEA | Acid | acid | —C(O)OH and | Molecular |
| Example | (g, mol) | (g, mol) | (g, mol) | —C(O)O⁻ groups | Weight |
| 7 | 37, 0.09 | 4.3, 0.06 | 3.2, 0.03 | 1 | 2100 |
| 8 | 61.6, 0.15 | 6.5, 0.09 | 3.2, 0.03 | 1.25 | 2580 |
| 9 | 98.6, 0.24 | 4.3, 0.06 | 3.2, 0.03 | 2.66 | 4560 |
| 10 | 61.6, 0.15 | 4.3, 0.06 | 3.2, 0.03 | 1.66 | 2640 |

At 25% solids and 50° C., the mixture containing the neutralized oligomer of Example 7 was visually determined to be a one-phase, clear, and stable solution; the mixture containing the neutralized oligomer of Example 8 was a one-phase, hazy solution. For Examples 9 and 10, the neutralized oligomer in IPA at 30% solids was diluted to 5% solids using IPA. Deionized water was added to each example (7-10) at three dilution levels to provide solutions containing 1000 ppm, 100 ppm, and 10 ppm of neutralized oligomer. For Examples 9 and 10, the 1000 ppm solutions were slightly cloudy, and the 100 ppm and 10 ppm solutions were clear.

The weight average molecular weights of the oligomers prepared in Examples 7-10 were determined by GPC and are listed in Table 2 (above).

The static surface tensions of Examples 1-10 were measured on a Kiruss K-12 tensiometer (available from Kruss GmbH, Hamburg, Germany) using the Du Nouy ring method at 20° C. The surface tensions measured for solutions containing 1000 ppm, 100 ppm, and 10 ppm of the surfactants of each example are reported in millinewtons per meter (mN/m) in Table 3 (below).

TABLE 3

| | Surface tension | Surface tension | Surface tension |
|---|---|---|---|
| Surfactant | 1000 ppm | 100 ppm | 10 ppm |
| Measured | dilution (mN/m) | dilution (mN/m) | dilution (mN/m) |
| Example 1 | 23.0 | 30.7 | 45.9 |
| Example 2 | 22.1 | 30.5 | 48.2 |
| Example 3 | 23.4 | 32.8 | 52.3 |
| Example 4 | 22.9 | 34.6 | 49.7 |
| Example 5 | 22.4 | 31.2 | 50.7 |
| Example 6 | 21.9 | 31.2 | 47.7 |
| Example 7 | 21.2 | 30.4 | 45.6 |
| Example 8 | 22.9 | 34.9 | 52.1 |
| Example 9 | 21.6 | 28.9 | 52.4 |
| Example 10 | 22.4 | 33.0 | 49.8 |

### Comparative Example 1

The procedure described in Example 1 was followed using MeFBSEA (74 g, 0.18 mol) and 3-mercaptopropionic acid (3.2 g, 0.03 mol) and omitting acrylic acid. The compound was insoluble in water at 1000 ppm, 100 ppm, and 10 ppm and could not be used to lower the surface tension of water.

### Examples 11-15

MeFBSEA, acrylic acid, and 3-mercaptopropionic acid, in the amounts indicated in Table 4, were combined in a 4-ounce pressure bottle. A solution of 2,2′-azobis(2-methylbutyronitrile) (400 mg, 2 mmol) in ethyl acetate (120 g) was prepared, and 24 g of this solution was added to each of Examples 11-14. A second solution of 2,2′-azobis(2-methylbutyronitrile) (400 mg, 2 mmol) in ethyl acetate (120 g) was prepared, and 24 g of this solution was added to Example 15. The resulting solution was purged with nitrogen at one liter per minute for 50 seconds and then heated under a nitrogen atmosphere for 50 hours at 60° C. in a rotating water bath.

The percent solids was determined for each example by heating an approximately one-gram sample in a vented oven for two hours at 105° C.; the monomers are completely volatile under these conditions. The percent conversion was calculated from the following equation:

Percent conversion=100[(percent solids×weight of solution)/weight of starting monomers].

The amounts of starting materials, the ratio of MeFBSEA to —C(O)OH and —C(O)O⁻ groups, the percent conversion, and the theoretical molecular weight, calculated from the molecular weight and ratios of the starting materials, are given in Table 4 (below).

TABLE 4

| | | | | Molar ratio of | | |
|---|---|---|---|---|---|---|
| | | Acrylic | Mercaptopropionic | MeFBSEA to | | |
| | MeFBSEA | Acid | acid | —C(O)OH and | Conversion | Molecular |
| Example | (g, mmol) | (g, mmol) | (g, mmol) | —C(O)O⁻ groups | (%) | Weight^{a} |
| 11 | 7.60, 18.5 | 0.33, 4.6 | 0.51, 4.8 | 2 | 98.9 | 1820 |
| 12 | 7.75, 18.8 | 0.35, 4.8 | 0.26, 2.4 | 2.7 | 97.7 | 3540^{b} |
| 13 | 7.29, 17.7 | 0.29, 4.0 | 0.15, 1.4 | 2 | 98.2 | 3610 |
| 14 | 7.75, 18.8 | 0.45, 6.2 | 0.17, 1.6 | 2.4 | 95.0 | 5330 |
| 15 | 7.6, 18.5 | 0.51, 7.1 | 0.12, 1.1 | 2.3 | 95.7 | 7120 |

^{a}theoretical molecular weight.
^{b}The weight average molecular weight measured by GPC was 4100.

### Example 16

MeFBSEA (7.6 g, 18.5 mmol), acrylic acid (0.33 g, 4.6 mmol), and mercaptosuccinic acid (0.35 g, 2.3 mmol) were combined in a 4-ounce pressure bottle, and a solution of 2,2′-azobis(2-methylbutyronitrile) (80 mg, 0.4 mmol) in ethyl acetate (24 g), prepared as the second solution described in Examples 11-15, was added to the mixture. The resulting solution was purged with nitrogen for 50 seconds and then heated under a nitrogen atmosphere for 50 hours at 60° C. in a rotating water bath. The percent conversion, calculated according to the equation shown in Examples 11-15, was 100%. The theoretical molecular weight, calculated from the molecular weight and ratios of the starting materials, of the oligomer was 3580, and the ratio of MeFBSEA to —C(O)OH and —C(O)O⁻ groups was 2.

### Example 17

MeFBSEA (372.0 g, 904.6 mmol), acrylic acid (16.3 g, 226 mmol), 3-mercaptopropionic acid (12.0 g, 113 mmol), 2,2′-azobis(2-methylbutyronitrile) (4.0 g, 20.1 mmol), and ethyl acetate (1200 g) were combined, and the resulting solution was divided into four 1-quart bottles. Each solution was purged with nitrogen at one liter per minute for two minutes and then heated under a nitrogen atmosphere for 44 hours at 60° C. in a rotating water bath. The contents of the four bottles were combined and concentrated under reduced pressure to provide 422.4 g of liquid. A one-gram sample of the liquid was heated for four hours at 105° C., and the residue was weighed to determine that the liquid was 92% solids. The percent conversion, calculated according to the equation shown in Examples 11-15, was 97%. The theoretical molecular weight of the oligomer, calculated from the molecular weight and ratios of the starting materials, was 3540, and the ratio of MeFBSEA to —C(O)OH and —C(O)O⁻ groups was 2.7. The weight average molecular weight measured by GPC was 3810.

### Comparative Examples (CE) 2 and 3

The procedure described for Examples 11-15 was followed using 24 g of the second solution of 2,2′-azobis(2-methylbutyronitrile in ethyl acetate and using the amounts of components indicated in Table 5 (below).

TABLE 5

| | | | | Molar ratio of | | |
|---|---|---|---|---|---|---|
| | | Acrylic | Mercaptopropionic | MeFBSEA to | | |
| | MeFBSEA | Acid | acid | —C(O)OH and | Conversion | Molecular |
| | (g, mmol) | (g, mmol) | (g, mmol) | —C(O)O⁻ groups | (%) | Weight^{a} |
| CE-2 | 7.6, 18.5 | 0.50, 6.9 | 0.06, 0.056 | 2.5 | 100.6 | 14130 |
| CE-3 | 7.6, 18.5 | 0.50, 6.9 | 0 | 2.67 | 98.7 | >20,000 |

^{a}theoretical molecular weight

### Evaluation of Examples in Floor Finish

An aqueous styrene-acrylic emulsion floor finish was obtained from Cook Composites and Polymers, Kansas City, Mo. The floor finish was similar to that marketed by Cook Composites and Polymers under the trade designation “SHIELD-8”; except that it contained no fluorinated surfactant or hydrosol emulsion leveler.

For each surfactant evaluated in floor finish (i.e., Examples 11 through 17 and Comparative Examples CE-2 and CE-3), the ethyl acetate was removed under reduced pressure, and the resulting oligomer was diluted with a 50:50 mixture of water and di(propylene glycol) methyl ether to a level of about 20% solids and neutralized with a small amount of potassium hydroxide. The resulting solution was further diluted with a 50:50 mixture of water and di(propylene glycol) methyl ether to a level of 1% solids. This solution was added to the floor finish at a level to provide 200 ppm of oligomer to the floor finish.

Five mL of the liquid floor finish, containing 200 ppm of fluorinated surfactant was applied to the center of a 12 inch×12 inch (30.48 cm×30.48 cm) pre-cleaned black vinyl composite floor tile, then spread with a piece of gauze or cheesecloth using figure eight-shaped strokes covering the entire surface area of the tile until an even coating was obtained. An “X” was then made by wiping the floor finish between diagonally opposed corners of the tile. The process was repeated until a total of five layers of coating had been applied, allowing each coating layer to dry for at least 25-30 minutes prior to reapplication.

A fluorinated surfactant that has been used in commercial floor finishes, obtained from 3 M Company under the trade designation “FLUORAD FC-129”, was also evaluated at 200 ppm in the floor finish formulation for the purposes of comparison.

### Wetting (0-5 Rating)

Wetting performance was determined by visually inspecting the coating for surface defects during and after drying of the final coat. Poor wetting is generally manifested as surface defects in the form of craters, pinholes, and the coating pulling in from the edges of the tile. Wetting performance values were determined as follows:

| Observation | Rating |
|---|---|
| Complete de-wetting of the coating. Coating is mainly | 0 |
| concentrated in small pools. | |
| Extreme de-wetting. Only small areas of continuous coating. | 1 |
| Mainly continuous coating, however, coating has numerous | 2 |
| craters and/or pinholes. Pronounced pulling from the edges. | |
| Few but obvious craters and/or pinholes in coating | 3 |
| Very few pinholes are small craters; small lower gloss areas. | 4 |
| No observation of craters, pinholes, or coating pulling | 5 |
| in from the edge. Wet coating remains smooth during dry down. | |
| Even gloss over entire surface. | |

### Leveling (0-5 Rating)

Leveling performance was also determined by visual inspection of the coating during and after drying of the final coat. Poor leveling can be determined through observation of figure eight strokes and the “X” applied during the coating process. The coating can appear uneven or have channels from application strokes. Leveling was evaluated using the following criteria:

| Observation | Rating |
|---|---|
| Deep channels or grooves in the X and figure eight pattern | 0 |
| Observation of X and all figure eight application strokes; | 1 |
| uneven thickness of coating | |
| Though the coating may appear smooth, can observe X and | 2 |
| all 8's | |
| Obvious observation of X and some figure eight patterns | 3 |
| Faint observation of X and little to no figure eight patterns | 4 |
| No observation of X or figure eights at any angle | 5 |

### 60° Gloss

The coated tiles were allowed to air dry for 7 days, and then 600 gloss was measured using a BYK-Gardner gloss meter available under the trade designation “MICRO-TRI-GLOSS METER” from Paul N. Gardner Co., Inc., Pompano Beach, Fla. The reported value is the average of six different measurements over the coated surface of the tile.

TABLE 5
Evaluation of Surfactants in Floor Finish

| Fluorosurfactant | Wetting | Leveling | |
|---|---|---|---|
| Identity | (0-5) | (0-5) | 60° Gloss |
| Example 11 | 3 | 2 | n.d.^{a} |
| Example 12 | 4 | 4 | 60 |
| Example 13 | 4 | 2 | 58 |
| Example 14 | 4 | 2 | 66 |
| Example 15 | 4 | 4 | 57 |
| Example 16 | 3 | 3 | 59 |
| Example 17 | 4 | 4 | 62 |
| CE-2 | 1 | 1 | 68 |
| CE-3 | 1 | 1 | 64 |
| “FC-129” | 4 | 4 | 62 |

^{a}not determined

The static surface tensions of Examples 18 and 19 were measured on a Kruss K-12 tensiometer (available from Kruss USA, Charlotte, N.C.) using a Wilhelmy platinum plate and a glass sample vessel at room temperature. An automatic dosimat and computer were used to dilute samples incrementally for surface tension measurement.

### Example 18

Example 18 was prepared as described in Examples 11-15 using MeFBSEA (7.60 g, 18.5 mmol), acrylic acid (0.33 g, 4.6 mmol), 3-mercaptopropionic acid (0.51 g, 4.8 mmol), and 2,2′-azobis(2-methylbutyronitrile) (80 mg, 0.4 mmol) in ethyl acetate. The theoretical molecular weight and molar ratio of MeFBSEA to —C(O)OH and —C(O)O⁻ groups were the same as for Example 11. The reaction was heated for 40 hours rather than 50 hours. A conversion of 99% was calculated. A ten-gram sample was evaporated under a stream of nitrogen for two days to provide 2.83 g of solid. The solid was diluted to 19.74% solids 1:1 methanol/DPM, and to 5.07 g of this solution was added 0.15 g of 20% aqueous sodium hydroxide. Deionized water was added to provide a 5000 ppm solution, and the surface tension was measured using the method described above. The results are shown in Table 6 (below).

TABLE 6

| Concentration (ppm) | Surface Tension (mN/m) |
|---|---|
| 0 | 72.2 |
| 12.6 | 71.0 |
| 32.6 | 64.7 |
| 63.8 | 53.3 |
| 112.5 | 42.5 |
| 187.8 | 40.2 |
| 302.4 | 39.2 |
| 473.3 | 37.6 |
| 720.2 | 34.1 |
| 1060.6 | 31.5 |
| 1501.6 | 29.2 |
| 2028.8 | 27.9 |
| 2601.6 | 27.6 |
| 5000.0 | 22.6 |

### Example 19

Example 19 was prepared as described in Examples 11-15 using the compounds and amounts indicated in Example 12 with the modifications that beta-carboxyethyl acrylate (0.69 g, 4.8 mmol) was used in place of acrylic acid and the reaction heating time was 40 hours instead of 50 hours. A conversion of 97% was calculated. A ten-gram sample was evaporated under a stream of nitrogen for two days to provide 2.88 g of solid. The solid was diluted to 14.77% solids 1:2 methanol/DPM, and to 6.77 g of this solution was added 0.26 g of 20% aqueous sodium hydroxide. Deionized water was added to provide a 5000 ppm solution, and the surface tension was measured according to the method described above. The results are shown in Table 7 (below).

TABLE 7

| Concentration (ppm) | Surface Tension (mN/m) |
|---|---|
| 0.0 | 71.9 |
| 12.6 | 69.4 |
| 32.6 | 66.3 |
| 63.8 | 63.2 |
| 112.5 | 59.7 |
| 187.8 | 55.9 |
| 302.4 | 51.4 |
| 473.3 | 46.7 |
| 720.2 | 42.4 |
| 1501.6 | 35.5 |
| 2028.8 | 33.9 |
| 2601.6 | 32.6 |
| 5000.0 | 30.3 |

Various modifications and alterations of this invention may be made by those skilled in the art without departing from the scope and spirit of this invention, and it should be understood that this invention is not to be unduly limited to the illustrative embodiments set forth herein.

1. A fluorinated surfactant having a weight average molecular weight in a range from 1200 to 10000 grams per mole, wherein the fluorinated surfactant comprises at least one component represented by formula (I): 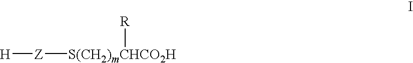
or a salt thereof, wherein
R is selected from the group consisting of —H, —CH₃, and —CH₂CO₂H;
m is an integer having a value from 0 to 11; and
Z is a divalent segment consisting of:
p divalent groups independently represented by formula (II): 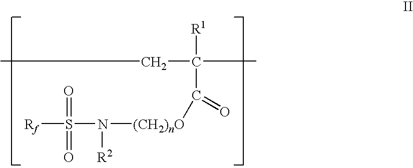
wherein
R¹ is selected from the group consisting of —H and —CH₃;
R² is an alkyl group having from 1 to 4 carbon atoms;
R_{f} is selected from the group consisting of —C₄F₉ and C₃F₇;
n is an integer having a value from 2 to 11; and
p is an integer having a value from 1 to 18; and
q divalent groups independently represented by formula (III): 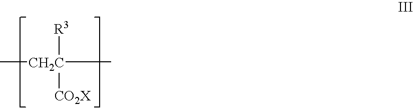
or a salt thereof, wherein
R³ is selected from the group consisting of H, —CH₃, and —CH₂CO₂H;
X is selected from the group consisting of —H and —CH₂CH₂CO₂H; and
q is an integer having a value from 1 to 35;
wherein the fluorinated surfactant has a combined total number of 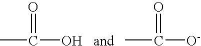
groups represented by k, and wherein p/k has a value from 0.5 to 3.

2. (canceled)

3. The fluorinated surfactant of claim 1, wherein R³ is —H.

4. The fluorinated surfactant of claim 1, preparable by copolymerizing components consisting of:
at least one first component independently represented by formula (IV): 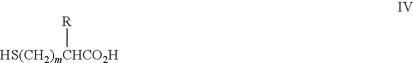
or a salt thereof, wherein
R is selected from the group consisting of —H, —CH₃, and —CH₂CO₂H; and
m is an integer having a value from 0 to 11;
at least one second component independently represented by formula (V): 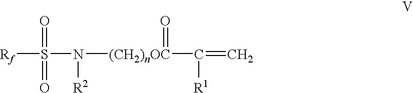
wherein
R¹ is selected from the group consisting of —H and —CH₃;
R² is an alkyl group having from 1 to 4 carbon atoms;
R_{f} is selected from the group consisting of —C₄F₉ and —C₃F₇; and
n is an integer having a value from 2 to 11; and
at least one third component independently selected from the group consisting of acrylic acid, methacrylic acid, β-carboxyethyl acrylate, β-carboxyethyl methacrylate, itaconic acid, and salts thereof,
wherein
said at least one first component and said at least one third component have a combined total number of moles of 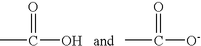
groups represented by j,
a combined total number of moles of said at least one second component is represented by g, and
g/j is in a range from 0.5 to 3; and
wherein amounts of said at least one first, at least one second and at least one third components are selected such that the fluorinated surfactant has a weight average molecular weight in a range from 1200 to 10000 grams per mole.

5. The fluorinated surfactant of claim 1, wherein R is —H or —CH₂CO₂H.

6. (canceled)

7. The fluorinated surfactant of claim 1, wherein R¹ is —H, R² is —CH₃ and R_{f} is —C₄F₉.

8-9. (canceled)

10. The fluorinated surfactant of claim 1, wherein the weight average molecular weight of the fluorinated surfactant has a value from 1500 to 8000 grams per mole.

11. The fluorinated surfactant of claim 10, wherein the weight average molecular weight of the fluorinated surfactant has a value from 1500 to 4000 grams per mole.

12. The fluorinated surfactant of claim 1, wherein the fluorinated surfactant has a solubility in water at 22° C. of at least 10 parts per million by weight.

13. (canceled)

14. A formulation comprising the fluorinated surfactant of claim 1 at least one of dissolved or dispersed in a liquid vehicle, the liquid vehicle comprising at least one of water or organic solvent.

15. The formulation of claim 14, wherein the fluorinated surfactant is present in an amount of at least 10 percent by weight, based on the total weight of the formulation.

16. The formulation of claim 14, wherein the fluorinated surfactant is present in an amount of at least 30 percent by weight, based on the total weight of the formulation.

17. The formulation of claim 14, wherein the fluorinated surfactant is present in an amount sufficient to reduce the surface tension of the liquid vehicle.

18. The formulation of claim 14, wherein the liquid vehicle comprises water, the formulation further comprising a polymeric material.

19. The formulation of claim 18, wherein the polymeric material is selected from the group consisting of an acrylic polymer, a polyurethane, polystyrene, and a copolymer of styrene and at least one acrylate.

20. A method of making a fluorinated surfactant, the method comprising copolymerizing components consisting of:
at least one first component independently represented by formula (IV): 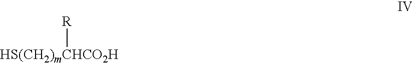
or a salt thereof, wherein
R is selected from the group consisting of —H, —CH₃, and —CH₂CO₂H; and
m is an integer having a value from 0 to 11;
at least one second component independently represented by formula (V): 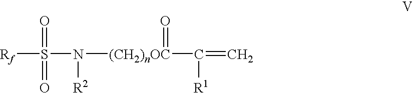
wherein
R¹ is selected from the group consisting of —H and —CH₃;
R² is an alkyl group having from 1 to 4 carbon atoms;
R_{f} is selected from the group consisting of —C₄F₉ and —C₃F₇; and
n is an integer having a value from 2 to 11; and
at least one third component independently selected from the group consisting of acrylic acid, methacrylic acid, β-carboxyethyl acrylate, β-carboxyethyl methacrylate, itaconic acid, and salts thereof,
wherein
said at least one first component and said at least one third component have a combined total number of moles of 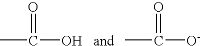
groups represented by j,
a combined total number of moles of said at least one second component is represented by g, and
g/j is in a range from 0.5 to 3; and
wherein amounts of said at least one first, at least one second and at least one third components are selected such that the fluorinated surfactant has a weight average molecular weight in a range from 1200 to 10000 grams per mole.

21. (canceled)

22. The method of claim 20, wherein R is —H or —CH₂CO₂H.

23. (canceled)

24. The method of claim 20, wherein R² is —CH₃ and R_{f} is —C₄F₉.

25. (canceled)

26. The method of claim 20, wherein the weight average molecular weight of the fluorinated surfactant is in a range from 1500 to 4000 grams per mole.

27. The method of claim 20, wherein copolymerizing is carried out in the presence of a free-radical initiator.

28. The method of claim 20, wherein said at least one third component is independently selected from the group consisting of acrylic acid, methacrylic acid, β-carboxyethyl acrylate, β-carboxyethyl methacrylate, and salts thereof.
